(19) United States
(12) Patent Application Publication
(10) Pub. No.: US 2020/0367324 A1
(43) Pub. Date: Nov. 19, 2020

(54) INDUCTION COIL STRUCTURAL UNIT AND METHOD FOR CONTROLLING AN INDUCTIVE HEATING PROCESS FOR AN INDUCTION COIL STRUCTURAL UNIT

(71) Applicant: HAIMER GMBH, Igenhausen, DE (US)

(72) Inventor: ANTONIN PODHRAZKY, JEMNICE (CZ)

(21) Appl. No.: 15/931,819

(22) Filed: May 14, 2020

(30) Foreign Application Priority Data
May 14, 2019 (DE) 102019112521

(51) Int. Cl. H05B 6/10; H05B 6/06; H05B 1/02; H05B 6/04; H05B 6/08; B23Q 23/00; B23B 31/40

(52) U.S. Cl. CPC H05B 6/10; H05B 6/06; H05B 1/023; B23B 31/40; H05B 6/08; B23Q 23/00; H05B 6/04

(57) ABSTRACT

An induction coil structural unit has an induction coil into which a sleeve portion of a tool holder can be inserted. In order to increase a degree of automation, a defined-preset test current is applied to the induction coil even before the beginning of an inductive heating process, a time/current curve is determined for the current and the inserted sleeve portion is recognized. Heating parameters are established for the sleeve portion and the inductive heating process is started on the basis of the heating parameters. The inductive heating process is interrupted at least once and, during the interruption, a defined-preset check current is applied and a further time/current curve for the sleeve portion is determined for this check current. A decision is made on the basis of the further time/current curve of the check current whether the heating process is continued or permanently ended.

### CROSS-REFERENCE TO RELATED APPLICATION

This application claims the priority, under 35 U.S.C. § 119, of German patent application DE 10 2019 112 521, filed May 14, 2019; the prior application is herewith incorporated by reference in its entirety.

### BACKGROUND OF THE INVENTION

### Field of the Invention

The invention relates to an induction coil structural unit with an induction coil, into which a sleeve portion of a tool holder can be inserted, and also to a method for controlling an inductive heating process for an induction coil structural unit with a sleeve portion of a tool holder inserted in an induction coil of the induction coil structural unit.

Such induction coil structural units of the type in question are described, for example, in the commonly assigned publication EP 1 867 211 A1 and its counterpart US 2008/0277386 A1.

These known induction coil structural units are used for thermally expanding tool holders by means of alternating magnetic fields that can be generated by induction coils and the eddy currents induced as a result in the tool holders inserted in the induction coils of the induction coil structural units, in order to be able in this expanded state of the tool holder to fit in there a tool which, after a cooling-down process of the tool holder, is then firmly and symmetrically held by the latter. This process is also referred to—for short—as induction shrink fitting of tools in tool holders and is known as such.

For further description of the technical and operational background, reference should therefore be made to the cited patent application, which is herewith incorporated by reference.

With such a known induction coil structural unit, there is the problem however that, for efficient operation of the same, i.e. induction shrink fitting of tools in tool holders, especially involving heating the tool holders, the induction coil structural unit must in each case be set individually to the tool holder held therein just then/at the particular time with regard to various operating parameters, which requires a high degree of manual intervention and consequently under some circumstances significantly prolongs the cycle times for changing a tool in different types of tool holders. What is more, manual interventions also always represent potential sources of error.

If, on the other hand, such setting to the tool holder held at the particular moment is not performed, or is performed wrongly, under some circumstances operation of the induction coil structural unit may be inefficient, since the intended eddy currents are not suitably induced in the tool holder. In particularly unfavorable cases, the tool holder may even become overheated and consequently be destroyed.

### SUMMARY OF THE INVENTION

It is accordingly an object of the invention to provide an induction coil structural unit and also a method for controlling an inductive heating process for an induction coil structural unit, which overcome s the above-mentioned and other disadvantages of the heretofore-known devices and methods of this general type and which provides for the induction coil structural unit to have, in particular, an increased degree of automation and to consequently be operated with great operational reliability and shorter cycle times.

With the above and other objects in view there is provided, in accordance with the invention, a method of controlling an inductive heating process for an induction coil structural unit having an induction coil and a sleeve portion of a tool holder inserted in the induction coil, the method comprising:

applying a defined-preset test current (current pulse) to the induction coil prior to beginning an inductive heating process in the sleeve portion of the tool holder inserted in the induction coil, determining a time/current curve for the test current in the sleeve portion inserted in the induction coil, and detecting the inserted sleeve portion by way of the time/current curve;

based on the detection, establishing heating parameters for the sleeve portion inserted in the induction coil and starting the inductive heating process based on the heating parameters established for the detected sleeve portion;

interrupting the inductive heating process at least once and, while the inductive hearing process is interrupted, applying a defined-preset check current (current pulse) to the induction coil with the sleeve portion of the tool holder inserted in the induction coil and determining a further time/current curve for the check current in the sleeve portion inserted in the induction coil; and

deciding, based on the further time/current curve of the check current, whether the heating process should be continued or permanently ended.

In other words, the objects of the invention are achieved by an induction coil structural unit and a method for controlling an inductive heating process for an induction coil structural unit with the features of the respective independent claim. Advantageous developments of the invention are the subject of dependent claims and also of the following description and concern both the induction coil structural unit and the method for controlling an inductive heating process for an induction coil structural unit.

The induction coil structural unit and the method for controlling an inductive heating process for an induction coil structural unit provide an induction coil in the induction coil structural unit into which a sleeve portion of a tool holder can be inserted (as far as the arrangement is concerned) or is inserted (as far as the method is concerned).

In the case of the method for controlling an inductive heating process for an induction coil structural unit, for example a shrinking device, with the sleeve portion of a tool holder inserted in an induction coil of the induction coil structural unit, it is provided that a defined-preset current (e.g., a test current, test pulse) is applied to the induction coil even before the beginning of an inductive heating process in the sleeve portion inserted in the induction coil.

A time/current curve for the sleeve portion inserted in the induction coil is determined for this (test) current (test pulse).

On the basis of the time/current curve of the (test) current, the inserted sleeve portion is detected.

Furthermore, on the basis of the detection, heating parameters are then established for the sleeve portion inserted in the induction coil and the inductive heating process is started on the basis of the heating parameters established for the detected sleeve portion.

The inductive heating process is then interrupted at least once.

During the interruption, once again a defined-preset (check) current (check pulse) is applied to the induction coil with the sleeve portion inserted in the induction coil and a further time/current curve for the sleeve portion inserted in the induction coil is determined for this (check) current (check pulse).

On the basis of the further time/current curve of the (check) current, it is then decided whether the heating process is continued or (permanently) ended.

In this case, “defined” (with respect to the (test) current (test pulse) and/or the (check) current (check pulse)) may be understood as meaning that parameters determining a current, which consequently describe the current (“current parameters”), are established in advance, i.e. preset.

Thus, for example, the defined-preset (test) current (test pulse) and/or the defined-preset (check) current (check pulse) may be defined or preset on the basis of current size, current waveform, frequency and/or duration of effect (“current parameters”).

When correspondingly establishing a current in such a way—on the basis—for example—of the previously described parameters—the (test) current (test pulse) and/or the (check) current (check pulse) may be at least one (current) pulse, i.e. a surge-like current with a surge-like current profile.

It has been found to be expedient that the (test) current (test pulse) and/or the (check) current (check pulse) comprises more than one (current) pulse, i.e. two or more ((temporally) successive) (current) pulses; the time/current curve determined from them has greater individuality (for a respectively inserted sleeve portion) and distinguishability (of the same).

Furthermore, it is also additionally expedient if the (test) current (test pulse) and/or the (check) current (check pulse) are the same; this makes comparability of the time/current curves possible.

In this case, a time/current curve may be a current intensity profile or a voltage profile.

Furthermore, it may also be expedient to accomplish the determination of the time/current curve of the (test) current (test pulse) or of the (check) current (check pulse) by measurement. A corresponding measuring instrument (or a functionally comparable circuit) may be provided in the induction coil structural unit.

Such a measurement of the time/current curve of the (test) current (test pulse) or of the (check) current (check pulse) may in this case be carried out in an input circuit of a circuit of the induction coil structural unit and/or an intermediate circuit of the induction coil structural unit and/or an output circuit or at the induction coil. The same applies correspondingly in general to the determination of the time/current curve of the (test) current (test pulse) or of the (check) current (check pulse).

The measurements may also be carried out in parallel at a number of the points mentioned of the circuit.

The determined, in particular measured, time/current curve of the (test) current (test pulse) and/or the determined, in particular measured, time/current curve of the (test) current of the (check) current (check pulse) can then be evaluated.

Furthermore, it may also be expedient to normalize the time/current curve of the (test) current (test pulse) and/or the time/current curve of the (test) current of the (check) current (check pulse) to a reference voltage, for example to a German reference grid voltage. Such normalizing makes it possible for the method to be independent of a respective country with the respective grid voltage there.

“Detected” (in the detection of the inserted sleeve portion on the basis of the time/current curve of the (test) current (test pulse)) may mean that a specific property, for example a specific geometry, such as an outer diameter, is acknowledged or attributed on the basis of the time/current curve of the (test) current (test pulse) of the inserted sleeve portion.

In other words, in simplified terms, it is “assumed” on the basis of the time/current curve of the (test) current (test pulse)—or to put it another way—it is “deduced” from the time/current curve of the (test) current (test pulse) that the inserted sleeve portion is a specific sleeve portion of a specific type, for example with a most specific geometry, such as with a most specific outer diameter.

Thus, as a result, for example, an outer diameter can be determined on the basis of the time/current curve of the (test) current (test pulse) for an inserted sleeve portion.

In simplified, illustrative terms and by way of example of this, the time/current curve of the (test) current (test pulse) may be evaluated. In this case, one (or more) time/current curve characteristics may be determined, on the basis of which a variable of the geometry, such as the outer diameter, of the inserted sleeve portion is determined/deduced.

The same can also be carried out correspondingly for the or with the time/current curve of the (check) current (check pulse), wherein one (or more) time/current curve characteristics may then also be determined. On the basis of this, for example a heating state for the inserted sleeve portion may then be determined/deduced.

Such a time/current curve characteristic may be for example a surface area, an amplitude, in particular an amplitude extreme, a number and/or a time interval of zero crossings, a flank steepness and/or a tangent in the case of the time/current curve or a characteristic deduced from it, in particular statistically deduced.

It may also be particularly expedient to combine a number of the aforementioned characteristics to form the time/current curve characteristic; in this way, the significance of the time/current curve characteristic can be increased.

If the inserted sleeve portion is then considered to be or has been detected, heating parameters are (or can be) determined or established for the inserted sleeve portion.

Such heating parameters may be in particular a time for the heating process, for example an overall heating time of the heating process and/or a time for an initial heating of the or in the heating process and/or a shrinking/heating frequency and/or a shrinking/heating temperature and/or also a change-in-inductance parameter and/or a change-in-resistance parameter.

The time for the initial heating of the heating process may be for example ⅓ to ½ of the time for the heating process.

On the basis of or using these heating parameters established for the detected sleeve portion, the inductive heating process is then started.

If with the sleeve portion of the tool holder inserted in the induction coil of the induction coil structural unit no heating has so far been carried out there in the induction coil, the beginning of the heating process can be referred to as initial heating. A subsequent (heating) phase or subsequent phase of the heating process can be referred to as subsequent heating. If no heating of the sleeve portion inserted in the induction coil of the induction coil structural unit takes place any longer there in the induction coil, this can be considered to be ending of the heating process.

It is also expedient to carry out or initiate the at least single interruption, i.e. the first interruption, after a presettable (initial) heating period. This (initial) heating period may be dependent on a presettable overall heating time, for example a specific fraction of the overall heating time, such as one third or two thirds of the overall heating time—or may be established as an absolute time period, such as one second or one and a half seconds.

Furthermore, in order to improve the carrying out of a (check) current (check pulse), it may be provided that, during an interruption of the heating process, before applying the further, defined-preset (check) current (check pulse), a charging process is carried out in a structural unit generating the further defined-preset (check) current (check pulse).

Such charging may take place for example by a capacitor of an oscillating circuit being charged in the charging process.

The same can correspondingly also be carried out for a, or with a, repeated interruption of the heating process.

A repeated interruption of the heating process may for example take place in the form that—if the heating process is thus interrupted a number of times—during each interruption once again the defined-preset (check) current (check pulse) is applied to the induction coil with the sleeve portion inserted in the induction coil; a further time/current curve for the sleeve portion inserted in the induction coil is determined for this (check) current (check pulse) and it is decided on the basis of the further time/current curve whether the heating process is continued or permanently ended after the respective interruption.

Also for this or in this case, the described time/current curve characteristics may be determined or the described evaluations carried out—for the respective (check) currents (check pulses).

It may then also be expedient here that the decision to continue the heating process is taken in dependence on a preset change of the time/current curve of the (test) current.

In other words, in simplified terms, a time/current curve of the (check) current is compared with the time/current curve of the (test) current, for example by a time/current curve characteristic comparison, wherein in particular a—presettable—change of the time/current curve of the (test) current or of the corresponding time/current characteristic, can be taken into consideration or taken into account in the calculation thereof.

Such a change—that can be taken into consideration or is preset—of the time/current curve of the (test) current (or its characteristic) may be caused by a temperature-dependent change in an inductance and/or an electrical property, such as an electrical resistance, in a sleeve portion of a tool holder. This temperature-dependent change in an inductance or an electrical property/an electrical resistance in a sleeve portion of a tool holder may expediently be described using an, in particular empirically determined, change-in-inductance parameter and/or an electrical (resistance) parameter or change-in-resistance parameter.

This is based on the realization according to the invention that the inductance of the induction coil and/or an electrical property, such as the electrical resistance, changes in dependence on the heating or the heating temperature of the inserted sleeve portion.

This change—and so thereby also a limit (limit value) for a heating or heating temperature in the case of the inserted sleeve portion can be taken into consideration by a—presettable—parameter, in particular a parameter dependent on the geometry and/or the material of the inserted sleeve portion, such as an outer diameter of the inserted sleeve portion (other dependences may also be taken into consideration here), such as the mentioned change-in-inductance parameter or the mentioned change-in-resistance parameter.

The change-in-inductance parameter may thus also expediently be dependent on the material of the sleeve portion. The same also applies correspondingly to the electrical resistance parameter.

In illustrative terms, by using such a parameter and the time/current curve of the (test) current (test pulse), a limiting time/current curve or limiting time/current curve characteristic (i.e. a (heating) termination criterion for an admissible heating temperature in the case of the inserted sleeve portion) may be defined, which limiting time/current curve or limiting time/current curve characteristic can be compared with the (respective) time/current curve of the (check) current or its time/current curve characteristic.

If, for example, the time/current curve of the (respective) (check) current then overshoots (or undershoots) this admissible limiting change or limit, the heating of the inserted sleeve portion may be terminated and thus heating (beyond such a limit) prevented (“protection from overheating”).

Furthermore, a heating phase or its duration between two interruptions may also be established on the basis of described criteria, for example in dependence on the heating period (fraction) or an absolute presettable (intermediate) heating period.

Furthermore, it is also possible that a number of further defined-preset (adaptation) currents (adaptation pulses) are applied to the induction coil, in particular even before the beginning or at the start of the inductive heating process in the sleeve portion inserted in the induction coil, in particular without heating being carried out in the case of the inserted sleeve portion between two of the (adaptation) currents (adaptation pulses), and that time/current curves for the sleeve portion inserted in the induction coil are determined for these (adaptation) currents (adaptation pulses).

Furthermore, on the basis of the time/current curves of the (adaptation) currents, a shrinking/heating frequency, generally a current parameter, can then be established in the case of or for the (heating) current to be applied to the induction coil.

Thus, if, for example, these (adaptation) currents (adaptation pulses) are applied before the beginning of the inductive heating process in the sleeve portion inserted in the induction coil, an (adaptation) current (adaptation pulse) may at the same time also be the (test) current (test pulse), or vice versa.

Definitions, characteristic time/current curve values, evaluations, measurements, such as in the case of the (test) current (test pulse) and/or the (check) current (check pulse), may also be provided for an (adaptation) current (adaptation pulse).

Thus, it may in particular also be provided to evaluate the time/current curves of the (adaptation) currents, wherein a time/current curve characteristic must be determined in each case in the evaluation for the time/current curves of the (adaptation) currents and these characteristics must be compared.

Thus, if, for example, a number of (adaptation) currents (adaptation pulses) are applied (for a short time) one after the other, wherein each has a changed current parameter, for example different frequencies in each case, in this way knowledge of a resonant frequency for the inserted sleeve portion can be acquired, and can be used for establishing the frequency for the (heating) current (i.e. the shrinking/heating frequency).

It is thus expedient in particular to establish the frequency for the (heating) current (i.e. the shrinking/heating frequency) close to the resonant frequency, for example “just” above it; as the shrinking/heating frequency approaches the resonant frequency, the efficiency/effectiveness of the heating increases. Establishing the shrinking/heating frequency as the same as the resonant frequency should be avoided; otherwise, resonant effects may lead to overloading of components in the induction coil structural unit.

Also provided in the induction coil structural unit—for carrying out the method—is a circuit, by means of which the (test) current (test pulse) and the (check) current can be generated.

Furthermore, also provided in the induction coil structural unit is a control unit, by means of which the induction coil and the circuit can be controlled. The control unit is additionally designed in such a way that—in short—the method can be carried out (in its main features, such as in particular also with all of the previously described refinements and developments).

In other words, In other words, the control unit controlling the induction coil and the circuit is designed in such a way that

the defined-preset (test) current (test pulse) can be applied to the induction coil even before the beginning of an inductive heating process in the sleeve portion inserted in the induction coil, a time/current curve for the sleeve portion inserted in the induction coil can be determined for this (test) current (test pulse) and the inserted sleeve portion can be detected on the basis of the time/current curve of the (test) current,

on the basis of the detection, heating parameters can be established for the sleeve portion inserted in the induction coil and the inductive heating process can be started on the basis of the heating parameters established for the detected sleeve portion,

the inductive heating process can be interrupted at least once; during the interruption, once again a defined-preset (check) current (check pulse) can be applied to the induction coil with the sleeve portion inserted in the induction coil and a further time/current curve for the sleeve portion inserted in the induction coil can be determined for this (check) current (check pulse) and

it can be decided on the basis of the further time/current curve of the (check) current whether the heating process is continued or permanently ended.

It may be expedient that the circuit has at least one power semiconductor component, in particular at least one insulated-gate bipolar transistor (IGBT) and/or a metal-oxide semiconductor field-effect transistor (MOSFET); these have good on-state behavior, high reverse voltages and robustness—and in addition can be driven almost without any power.

The fact that the method and the induction coil structural unit allow to the greatest extent automatic or automated operation, i.e. the inductive shrinking of tools in tool holders, specifically the heating of the tool holders, to be carried out for a tool holder in each case inserted just then in the induction coil structural unit means that manual interventions for setting operating parameters are rendered superfluous, so that on the one hand the time previously required for this is saved and on the other hand the automatic/automated operation also allows compliance with high standards with regard to operational reliability and tolerances, in order to be able to ensure operation of the structural unit according to regulations. Efficient protection from overheating of a tool holder to be heated/expanded can also be brought about by the method and with the induction coil structural unit.

The description given so far of advantageous refinements of the invention includes numerous features that are reproduced in the individual dependent patent claims, in some cases together. However, these features may expediently also be considered individually and combined into appropriate further combinations.

In particular, these features can be respectively combined individually and in any suitable combination with the method according to the invention.

Even though some terms are used in each case in the singular or in combination with a numeral in the description and/or in the patent claims, the scope of the invention is not intended to be limited to the singular or the respective numeral for these terms. Furthermore, the words “a” or “an” are not to be understood as numerical words, but rather as indefinite articles.

Other features which are considered as characteristic for the invention are set forth in the appended claims.

Although the invention is illustrated and described herein as embodied in induction coil structural unit and method for controlling an inductive heating process for an induction coil structural unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an induction coil structural unit according to one embodiment in a central longitudinal section;

FIG. 2 shows a circuit diagram of a circuit for feeding an induction coil which can be used for an induction coil structural unit;

FIG. 3 shows a test pulse (with one voltage pulse) that can be applied to an induction coil and the associated time/current curve;

FIG. 4 shows a test pulse (with three voltage pulses) that can be applied to an induction coil and the associated time/current curve;

FIG. 5 (schematically) shows a time/current curve profile in the case of heating or a shrinking process;

FIG. 6 (schematically) shows a circuit diagram of a circuit for the controlled feeding of an induction coil which can be used for an induction coil structural unit.

### DETAILED DESCRIPTION OF THE INVENTION

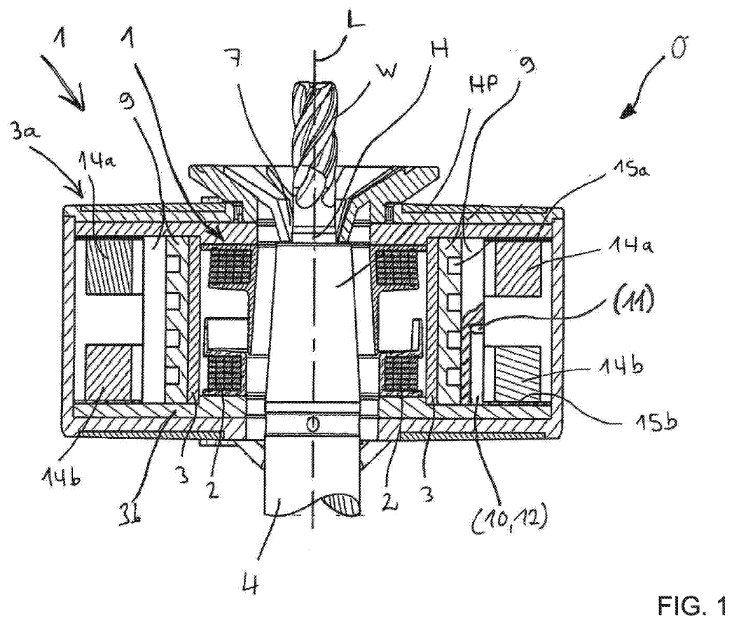

Referring now to the figures of the drawing in detail and first, particularly, to FIG. 1 thereof, there is shown a basic construction of an induction coil structural unit, which on account of its function intended here is also to be referred to hereinafter as a shrinking device.

As FIG. 1 illustrates, the shrinking device 0 provides an induction coil 1 with individual turns 2, in the center of which a tool holder 4 is pushed in, in order to shrink fit the holding shank H of a tool W, such as here for example a milling cutter, in the sleeve portion HP.

The functional principle on which the shrink fitting is based is described in more detail in German published patent application DE 199 15 412 A1. Its content is hereby incorporated by reference.

On its outer circumference, the induction coil 1 is provided with a first casing 3 of electrically non-conducting and magnetically conducting material.

Typically, the first casing 3 consists either of a ferrite or a metal powder or sintered metal material, the individual particles of which are separated from one another in an electrically insulating manner and which in this way are, considered altogether, substantially magnetically conducting and electrically non-conducting.

The first casing 3 is also configured in such a way that it is completely uninterrupted in the circumferential direction, that is to say completely covers the circumferential surface of the induction coil 1, so that also in theory no “magnetic gaps” remain, apart from irrelevant local apertures, such as for instance individual and/or small local bores or the like.

As FIG. 1 also shows furthermore, in the shrinking device 0, the shielding of magnetically conducting and electrically non-conducting material is not just confined to the first casing 3.

Instead, at least one end face, better both end faces, of the first casing 3 is/are adjoined by a magnetic covering 3a, 3b of said material, which generally contact(s) the first casing 3.

On the end face of the induction coil 1 that is facing away from the tool holder 4, the magnetic covering 3a is preferably formed as an entirely or preferably partly exchangeable pole shoe, i.e. as an annular structure with a central opening, which forms a passage 7 for the tool W to be clamp-fitted.

On the end face of the induction coil 1 that is facing toward the tool holder 4, the magnetic covering 3b is preferably designed as an intrinsically planar annular disk, which ideally reaches completely over the windings of the induction coil 1 and has a central passage for the sleeve portion HP.

In order to improve the shielding even further, as FIG. 1 also shows, the induction coil 1 and its first casing 3 are surrounded at the outer circumference of the latter by a second casing 9—to be precise in such a way that the first casing 3 and the second casing 9 touch one another, ideally over most of or the entirety of their circumferential surfaces facing one another.

This second casing 9 is produced from magnetically non-conductive and electrically conductive material, for example, aluminum.

“Electrically conductive” is understood here as meaning not only material that is merely electrically conductive locally, as it were “on a particle level”, but material that allows the formation of eddy currents to a relevant extent.

What is special about the second casing 9 is that it is preferably designed in such a way and preferably made so thick in the radial direction that, under the influence of the stray field of the induction coil 1 passing through it, eddy currents that bring about a weakening of the undesired stray field are generated in it.

Furthermore, the second casing 9 is surrounded at its circumference by the power semiconductor components 10 to be explained in still more detail below, which are arranged (only indicated) directly at the outer circumference of the second casing 9 in clearances 11 there.

These power semiconductor components 10 have two large main areas and four small side areas. The large main areas are preferably over four times larger than each of the individual side areas.

The power semiconductor components 10 are arranged in such a way that one of their large main areas is in heat-conducting contact with the second casing 9, generally at the outer circumference of the latter, wherein the large main area concerned of the power semiconductor component 10 is adhesively attached to the circumferential surface of the second casing 9 with the aid of a heat-conducting adhesive.

Each of the power semiconductor components 10 has three terminals 12 for supplying voltage (only indicated).

Furthermore, as FIG. 1 also shows, at the outer circumference of the induction coil 1, capacitors 14a, 14b are grouped around it.

The capacitors 14a are preferably smoothing capacitors, which directly form part of a power circuit; the capacitors 14b are preferably oscillating circuit capacitors, which likewise directly form part of the power circuit.

In order to connect the capacitors 14a, 14b electrically, provided here are a number of electrical circuit boards 15a, 15b, which respectively reach around the outer circumference of the induction coil 1.

Each of these circuit boards 15a, 15b preferably forms an annular disk. Each of the circuit boards 15a, 15b preferably consists of FR4 or similar materials customary for circuit boards.

As can also be seen in FIG. 1, the axis of rotational symmetry of each of the two circuit boards 15a, 15b, configured here as annular circuit board disks, is coaxial here to the longitudinal axis L of the induction coil (also of the tool holder 4/tool W).

The upper of the two electrical circuit boards 15a carries the smoothing capacitors 14a, the terminal lugs of which pass through the upper circuit board 15a or are connected with the aid of SMD technology to the upper circuit board 15a, so that the smoothing capacitors 14a hang down from the upper circuit board 15a.

The lower of the two circuit boards 15b is constructed correspondingly; the oscillating circuit capacitors 14b project upwardly from it.

Illustratively summarized, the power semiconductors 10 form a first imaginary cylinder, which annularly surrounds the induction coil 1; the capacitors 14a, 14b form a second imaginary cylinder, which annularly surrounds the first imaginary cylinder; the capacitors 14a, 14b, with only little sensitivity to the stray field, form the imaginary outer cylinder, while the power semiconductor components 10, requiring an installation space that is as free as possible from stray field, form the imaginary inner cylinder.

As FIG. 1 further shows, the induction coil 1 is not “fully wound” over its entire length in the direction of its longitudinal axis L. Instead, it consists—here—of two generally cylindrical winding assemblies. These respectively form an end face of the induction coil 1. They maintain a distance from one another, which—here by way of example—is greater by about a factor of at least 1.5 than the extent of each of the winding assemblies in the direction of the longitudinal axis L of the induction coil 1.

Such an induction coil 1 contributes to reducing the reactive power, since it is missing the windings in the “middle region”, which are not absolutely required from the aspect of the most effective possible heating of the sleeve portion HP of the tool holder, but—if present—have the tendency to produce additional reactive power without making any really appreciable contribution to the heating.

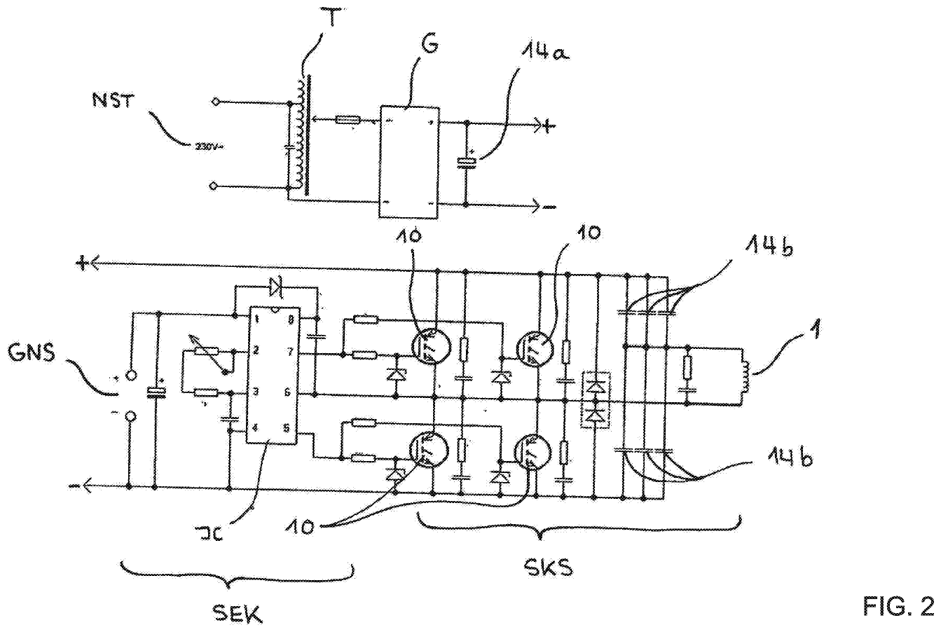

In order to supply the induction coil 1—with lowest possible reactive power losses—, an oscillating circuit SKS is provided (cf. FIG. 2).

In the oscillating circuit SKS, most of the energy required oscillates periodically (at high frequency) back and forth between the induction coil 1 and a capacitor unit 14a, 14b. As a result, in each period or periodically, only the energy drawn from the oscillating circuit SKS by its heating power and its other power loss has to be replenished. This does away with the previous, very high reactive power losses.

As FIG. 2 shows, the power electronics feeding the induction coil 1 are fed on the input side with the generally available line current NST, which in Europe is 230 V/50 Hz/16 Aₘₐₓ (in other countries corresponding values, including in the United States it is 110 V/60 Hz).

As FIG. 2 also shows, the line current NST is then stepped up to a higher voltage (transformer T), in order to reduce the currents flowing for the preset power output.

The current drawn from the grid is converted by the rectifier G into DC current, which for its part is smoothed by the smoothing capacitor or capacitors 14a.

The actual oscillating circuit SKS is fed with this DC current.

The backbone of the oscillating circuit SKS is formed by the power semiconductor components 10, the oscillating circuit capacitors 14b and the induction coil 1 serving for shrink fitting.

The oscillating circuit SKS is controlled in an open-loop or closed-loop manner by control electronics SEK, which are substantially formed as an IC and are fed by way of a dedicated input GNS with DC low voltage, which is tapped if applicable downstream of the rectifier G and the smoothing capacitor or capacitors 14a by way of a corresponding voltage divider resistance.

The power semiconductor components 10 are preferably implemented by transistors of the “insulated-gate bipolar transistor” type, IGBT for short.

The control electronics SEK switch the power semiconductor components 10/IGBT with a frequency that presets the operating frequency occurring at the oscillating circuit SKS.

It is important that the oscillating circuit SKS never operates exactly in resonance, which lies with a phase shift between voltage U and current I of cos φ=1.

This would lead here to rapid destruction of the power semiconductor components 10 by the voltage peaks. Instead, the control electronics SEK are designed in such a way that they operate the power electronics or the oscillating circuit SKS thereof in a presettable operating range, which only lies close to the resonance or natural frequency of the system.

Preferably, the oscillating circuit is controlled in an open-loop or closed-loop manner in such a way that 0.9≤cos φ≤0.99. Particularly favorable are values that lie in the range 0.95≤cos φ≤0.98. This leads once again to avoidance of voltage peaks and therefore further advances miniaturization.

In order to operate the shrinking unit 1 with a specific operational reliability, the shrinking device 0 is equipped with automatic heating control, which makes automated shrinkage operation possible.

This heating control is implemented by corresponding control in the shrinking device 0, which—in principle—is based on an observation of the inductance or a change in it during the operation of the shrinking device 0.

The inductance L, with u=L*di/dt (u: voltage, i: current intensity), is a characteristic variable of coils flowed through by alternating current.

In the case of inductive shrinking units or shrinking devices, the tool holder pushed with its sleeve portion into the space enclosed circumferentially by the induction coil forms an essential part of the magnetic circuit. To be specific, the sleeve portion forms the metal core of the induction coil. The degree of the inductance to be measured therefore decisively depends on the degree to which the sleeve portion fills the center or the so-called core of the induction coil, i.e. whether the sleeve portion concerned has a smaller or larger (outer) diameter or more or less mass.

In this case, the measurable inductance (and the resistance) of an induction coil used for shrinking depends not only on the geometry of the sleeve portion, but also on the temperature of the sleeve portion of the tool holder.

Both can be used—in a utilizable and controllable sense—(first) to determine/detect—in an automated manner—the geometry of a sleeve portion (A) and (then) to monitor/control the heating process (B)—, in order in this way to improve the reliability of a shrinking device—while avoiding sources of “manual” errors, because it is automated.

Optionally, as a result, a suitable shrinking frequency (operating frequency) can also be determined (C).
(A) (Automatic) detection of the tool holder/sleeve portion inserted at the particular time in the shrinking device or its induction coil

(A1) Creation of Digital Fingerprints

The number of different tool holders that come into consideration for use on the shrinking device is finite.

As a result of this, all of the, or at least the most important, tool holders that are used on the shrinking device can or are measured, in particular geometrically, and parameterized, for example by the manufacturer. The outer diameter of the sleeve portion of a tool holder is a (characteristic) variable that is relevant in particular in this case for a tool holder.
All of these data—with respect to the tool holder or sleeve portion—are stored in the shrinking device 0.

Furthermore, for each measured tool holder, a digital fingerprint describing it (inductively) is determined or created.

The degree of the current consumption by the induction coil in the course of a specific time unit serves for this. In other words, the time/current curve for a specific, preset (defined) time interval.

In order to determine such a digital fingerprint—characterizing a specific tool holder—a current of a known current size, current waveform, frequency and duration of effect, i.e. a test pulse, is applied with the aid of a precisely operating power source to the induction coil—having the “cold” tool holder or its sleeve portion (“test pulse”).

“Cold” means in this case that it is carried out substantially at room temperature before or independently of an (actual) shrinking process on the tool holder or its sleeve portion, that is to say on a “cold” tool holder or a “cold” sleeve portion.

Current size is understood here as meaning the amount of the maximum amplitude of the current, i.e. the profile of the current intensity. Current waveform is understood here as meaning the type of alternating voltage, for example a square-wave alternating voltage. Duration of effect is understood here as meaning the time period for which the test pulse is applied.

Depending on which outer diameter or which mass the sleeve portion concerned has, a different profile of the current consumption within the time unit concerned ((in simplified terms) as a response to the test pulse) is obtained for it, that is to say a different time/current curve (characterizing the respective sleeve portion or the respective tool holder), i.e. its magnetic/electrical or digital fingerprint (under “cold” conditions—see above in relation to the “cold” tool holder).

For all of the tool holders or sleeve portions to be taken into consideration for working on the shrinking device, the current consumption (generated by the defined test pulse) within a specific time unit, i.e. the time/current curve or the digital fingerprint, is measured and stored in the shrinking device 0—with respect to the tool holder or sleeve portion.

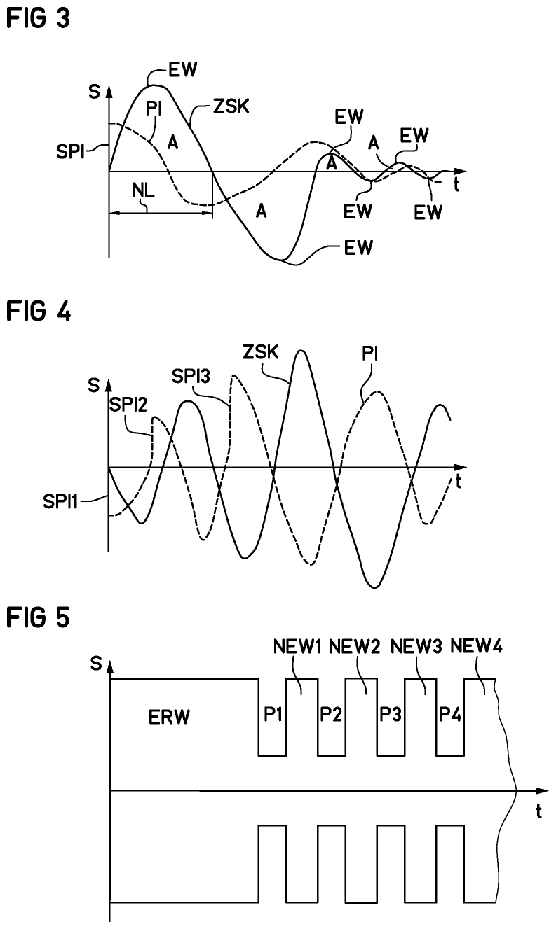

The time/current curves are in this case also “reduced” to the characteristics describing them, which in this case comprise the extreme values (EW), the surface area (A) and also the (time) interval of the zero crossings (NL) of the first period (cf. FIG. 3—indicated there), which are likewise stored in the shrinking device 0—with respect to the tool holder or sleeve portion.

FIGS. 3 and 4 (S=current (current intensity or voltage); t=time) show in each case by way of example a possible (applied) test pulse (PI) and the (measured) time/current curve (ZSK) for a “cold” tool holder 4. As FIGS. 3 and 4 show in comparison, the test pulse PI as shown in FIG. 3 has one voltage pulse (SPI), whereas the test pulse as shown in FIG. 4 comprises three voltage pulses (SPI1/2/3).

Furthermore, specific shrinkage parameters, such as a time for the heating process, a shrinking/heating frequency and a heating/shrinking temperature and also a change-in-inductance parameter and a change-in-resistance parameter (or related values) are then also stored in the shrinking device 0—with respect to the tool holder or sleeve portion.

This change-in-inductance parameter or change-in-resistance parameter in this case expresses or describes—with respect to the tool holder or sleeve portion—a change in the inductance with the temperature for a specific tool holder or sleeve portion.

(A2) Detection of a Tool Holder to be Shrunk by Means of the Digital Fingerprint

If then—for a shrinking process—a specific sleeve portion of a specific tool holder 4 to be shrunk is inserted into the induction coil 1, (which tool holder 4 is then expected to be detected), once again the corresponding test pulse is applied to the induction coil 1 having the “cold” tool holder to be detected, even before the beginning of the actual inductive heating process in the tool holder 4 (“cold conditions”).

The time/current curve then obtained as a result or measured is again “reduced” to the descriptive characteristics, EW, A and NL, which characteristics are then further compared with the characteristics stored—with respect to the tool holder or sleeve portion—in order thereby to determine which sleeve portion or which tool holder has been inserted into the induction coil.

Once the tool holder to be shrunk has thus been “detected”, thus in particular also its outer diameter and its shrinkage parameters (see above) are also established, on the basis of which the actual shrinking process then takes place.

(B) (Automated) Shrinking Process (FIG. 5)

During the shrinking process—then furthermore—the time/current curve for the tool holder 4 is measured (cf. FIG. 5), on the basis of which the shrinking process can be controlled.

In the shrinking process, as FIG. 5 illustrates (or as can be seen from the measured time/current curve), first an initial heating of the tool holder inserted in the induction coil or its sleeve portion (ERW) takes place according to the shrinkage parameters preset for this tool holder (determined by means of the digital fingerprint) or the initial heating time, of for example 3 to 4 seconds.

After the initial heating, the shrinking process is interrupted for a short time, for example for about 0.5 seconds (P1).

At the beginning of the interruption, complete charging of the capacitor units in the oscillating circuit SKS takes place.

Following that, a check pulse, identical to the test pulse, in short the same pulse, is applied to the induction coil—having the initially heated tool holder or its sleeve portion—and the time/current curve for this check pulse is measured (cannot be seen in FIG. 5).

This check-pulse time/current curve is once again “reduced” to the characteristics describing it, i.e. the extreme values (EW), the surface area (A) and also the (time) interval of the zero crossings (NL) of the first period.

On the basis of these characteristic values of the check pulse or at least one of these characteristic values, such as for example the surface area (A), it is decided whether the heating process or the shrinking process is continued (or not) (after the interruption (P1)) for the inserted tool holder or sleeve portion.

For this—by using the change-in-inductance parameter of the inserted tool holder or sleeve portion or its preset parameter value (the same by analogy can also be carried out with the change-in-resistance parameter) and also its characteristic values or its at least one characteristic value of the test pulse, for example the surface area (A) of the test pulse, —a maximum admissible change in the inductance (or resistance—see above for the analogous procedure), i.e. admissible limiting characteristic values or at least one admissible limiting characteristic value, is determined, for example by:

surface area A (or characteristic value) of the test pulse of the inserted tool holder—(surface area A (or characteristic value) of the test pulse of the inserted tool holder * preset change-in-inductance parameter value).

This is compared with the characteristic value of the check pulse, here again for example the surface area (A), for example by

surface area A (or characteristic value) of the check pulse of the inserted tool holder (<) or (=) or (>) surface area A (or characteristic value) of the test pulse of the inserted tool holder—(surface area A (or characteristic value) of the test pulse of the inserted tool holder * preset change-in-inductance parameter value) (“comparison of characteristic values”).

If the characteristic value of the check pulse deviates by a presettable criterion from the admissible limiting characteristic value, the shrinking process is ended, for example

surface area A (or characteristic value) of the check pulse of the inserted tool holder < or = or > surface area A (or characteristic value) of the test pulse of the inserted tool holder—(surface area A (or characteristic value) of the test pulse of the inserted tool holder * preset change-in-inductance parameter value) (“termination criterion”).

Otherwise, the continuation of the shrinking process takes place (still with the known shrinkage parameters) over a next, second (/further) shrinking phase (NEW1 (subsequent heating 1))—for example for a further 1.5 seconds.

After that, the shrinking process is interrupted for a second time (again), once again for about 0.5 seconds (P2)—and the testing is repeated. In other words, once again the charging of the capacitor units, the application of the check pulse and the “comparison of characteristic values” (see above) take place (“shrinkage regime”—P1 (testing)/NEW1, P2 (testing)/NEW2, P3 (testing)/NEW3 etc.).

If—then after this second shrinkage phase (NEW2)—the “termination criterion” (see above) is satisfied, the procedure is terminated. Otherwise shrinking is continued—on the basis of the above—“shrinkage regime” (P2 (testing)/NEW2, P3 (testing)/NEW3—cf. FIG. 5) until the “termination criterion” is satisfied.

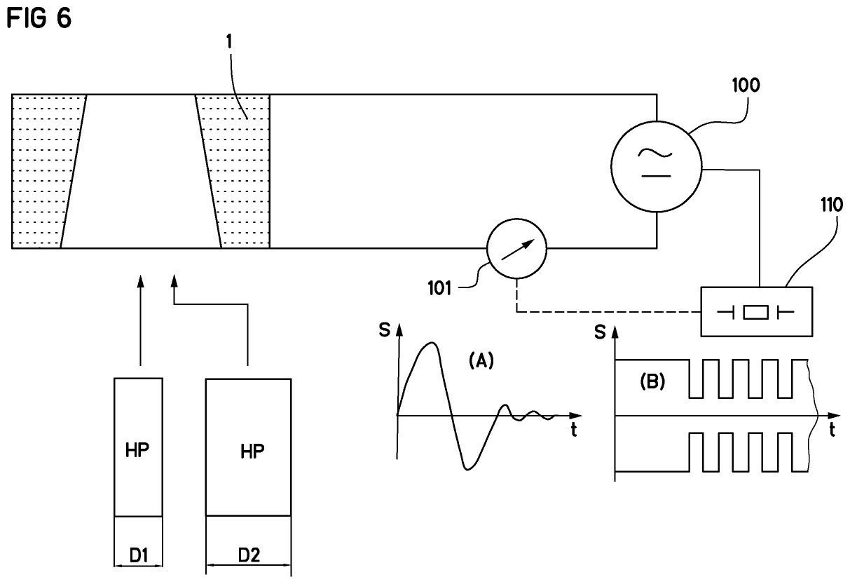

FIG. 6 illustrates how the—current/time curve-dependent—shrinking process in the shrinking device (cf. (A) and (B) and (C)) or its control can be implemented in terms of equipment.

As FIG. 6 shows, the induction coil 1 of the shrinking device 0 is fed by a power source 100, which also generates the test pulse and also the check pulses.

In one of the connection lines of the induction coil 1 there is a measuring instrument 101, which measures the time/current curve and which may be a (current) measuring instrument of a type of construction known per se.

By means of a control unit 110, the power source is then controlled—in a way corresponding to the described procedure ((A) and (B) and (C))—on the basis of the measured current/time curves.

(C) Automated Frequency Determination (Optional)

There follows a description of a method by means of which—for example—in the case of the shrinking process described above—a suitable shrinking frequency can be determined in an automated manner.

In this case, a suitable shrinking frequency means a shrinking frequency which lies “just” below the resonant frequency; as the shrinking/heating frequency approaches the resonant frequency, the efficiency/effectiveness of the heating increases, but there is still no risk of overloading of components in the induction coil structural unit, as there is when operating at the resonant frequency.

For this—before the beginning of the actual shrinking process—a number of further defined-preset (adaptation) currents or adaptation pulses, for example the same as the test pulse and/or the check pulses, are applied directly one after the other to the induction coil (with an inserted tool holder or sleeve portion—with different frequencies in each case.

Their time/current curves are again measured, these are reduced to the characteristic values and the characteristic values are compared.

If the effectiveness/efficiency of the heating is thus reflected—for example in the “extreme value (EW)” characteristic value (i.e. the greater the extreme value (EW), the more effective/more efficient the heating is), then in addition the “most effective/most efficient” (heating) frequency can be detected—and this can be presumed to be the resonant frequency.

A frequency just above this “most effective/most efficient” frequency—presumed to be the resonant frequency—can then be selected as the shrinking/heating frequency to be set/to be applied for the shrinking process and the shrinking process can be carried out on the basis of this frequency.

Although the invention has been illustrated more specifically and described in detail by the preferred exemplary embodiments, the invention is not restricted by the examples disclosed and other variations may be derived therefrom without departing from the scope of protection of the invention.

1. A method of controlling an inductive heating process for an induction coil structural unit having an induction coil and a sleeve portion of a tool holder inserted in the induction coil, the method comprising:
applying a defined-preset test current to the induction coil prior to beginning an inductive heating process in the sleeve portion of the tool holder inserted in the induction coil, determining a time/current curve for the test current in the sleeve portion inserted in the induction coil, and detecting the inserted sleeve portion by way of the time/current curve;
based on the detection, establishing heating parameters for the sleeve portion inserted in the induction coil and starting the inductive heating process based on the heating parameters established for the detected sleeve portion;
interrupting the inductive heating process at least once and, while the inductive hearing process is interrupted, applying a defined-preset check current to the induction coil with the sleeve portion of the tool holder inserted in the induction coil and determining a further time/current curve for the check current in the sleeve portion inserted in the induction coil; and
deciding, based on the further time/current curve of the check current, whether the heating process should be continued or terminated.

2. The method according to claim 1, wherein the test current is a test current pulse and the check current is a check current pulse.

3. The method according to claim 1, wherein the test current and/or the check current are defined-preset based on at least one of a current intensity, a current waveform, a frequency, or a duration of effect.

4. The method according to claim 1, wherein the test current and/or the check current comprises one, two, or more current pulses.

5. The method according to claim 1, wherein the test current and the check current are identical currents.

6. The method according to claim 1, which comprises measuring the time/current curve of the test current and/or of the check current and normalizing the time/current curve to a local reference grid voltage.

7. The method according to claim 1, which comprises evaluating the time/current curve of the test current and/or of the check current to thereby determine a time/current curve characteristic, and deducing from the time/current curve characteristic a geometry, or an outer diameter, of the inserted sleeve portion or a heating state for the inserted sleeve portion.

8. The method according to claim 7, wherein the time/current curve characteristic is a surface area, an amplitude, an amplitude extreme, a number and/or a time interval of zero crossings, a flank steepness and/or a tangent in a case of the time/current curve or a characteristic deduced therefrom.

9. The method according to claim 1, wherein the heating parameters established based on the detection are selected from the group consisting of a time for the heating process, a time for an initial heating of the heating process, a shrinking/heating frequency, a heating/shrinking temperature, a change-in-inductance parameter, and a change-in-resistance parameter.

10. The method according to claim 1, which comprises setting a time for the initial heating of the heating process to between one third and one half of a time for the heating process.

11. The method according to claim 1, which comprises during an interruption of the heating process, before applying the further, defined-preset check current, carrying out a charging process in a structural unit generating the further defined-preset check current, and optionally effecting the charging process by charging a capacitor of an oscillating circuit.

12. The method according to claim 1, which comprises:
interrupting the heating process a plurality of times, and during each interruption once again applying the check current to the induction coil with the sleeve portion inserted in the induction coil;
determining a further time/current curve for the sleeve portion inserted in the induction coil for the respective check current; and
deciding on a basis of the further time/current curve whether the heating process should be continued or permanently terminated after the respective interruption.

13. The method according to claim 12, wherein the step of deciding whether or not to continue the heating process is taken in dependence on a preset change of the time/current curve of the test current, and thereby determining the preset change of the time/current curve of the test current by using a change-in-inductance parameter.

14. The method according to claim 13, wherein the preset change of the time/current curve of the test current describes a temperature-dependent change in an inductance and/or a resistance in the sleeve portion of the tool holder.

15. The method according to claim 1, which comprises subjecting the induction coil to a plurality of further defined-preset adaptation current pulses, even before a beginning or at a start of the inductive heating process in the sleeve portion inserted in the induction coil, determining time/current curves for the sleeve portion inserted in the induction coil for the adaptation current pulses, and establishing a shrinking/heating frequency on a basis of the time/current curves of the adaptation current pulses.

16. The method according to claim 15, which comprises evaluating the time/current curves of the adaptation current pulses, and thereby determining time/current curve characteristics for each case, and comparing the characteristics.

17. An induction coil structural unit for carrying out the method according to claim 1 with an induction coil that is configured for receiving a sleeve portion of a tool holder, the induction coil structural unit comprising:
a circuit configured for generating a test current and a check current;
a control unit configured for controlling the induction coil and said circuit and for:
applying a defined-preset test current to the induction coil even before a beginning of an inductive heating process in the sleeve portion inserted in the induction coil, determining a time/current curve for the sleeve portion inserted in the induction coil for the test current, and detecting the inserted sleeve portion on a basis of the time/current curve of the test current;
based on the detection, establishing heating parameters for the sleeve portion inserted in the induction coil and starting the inductive heating process on a basis of the heating parameters established for the detected sleeve portion;
interrupting the inductive heating process can be interrupted at least once;
during the interruption, applying a defined-preset check current to the induction coil with the sleeve portion inserted in the induction coil and determining a further time/current curve for the sleeve portion inserted in the induction coil for the check current; and
deciding, based on the further time/current curve of the check current whether the heating process is continued or permanently terminated.

18. The induction coil structural unit according to claim 17, further comprising a measuring device for measuring the time/current curve for the sleeve portion inserted into the induction coil.

19. The induction coil structural unit according to claim 18, wherein said measuring device is one of a current measuring device or a voltage measuring device, and/or said measuring device is installed in one or more of an input circuit, an intermediate circuit, or an output circuit of said circuit for generating the test current and the check current.

20. The induction coil structural unit according to claim 17, wherein said circuit for generating the test current and the check current has at least one power semiconductor component being at least one insulated-gate bipolar transistor (IGBT) and/or a metal-oxide semiconductor field-effect transistor (MOSFET).
